(19) United States
(12) Patent Application Publication
(10) Pub. No.: US 2011/0047018 A1
(43) Pub. Date: Feb. 24, 2011

(54) Offer Management Method And System

(75) Inventors: John Lieblang, Clarkston, MI (US); Darrell Ward, Rochester Hills, MI (US); Don Steffes, Beverly Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: VALASSIS COMMUNICATIONS, INC., Livonia, MI (US)

(21) Appl. No.: 12/690,402

(22) Filed: Jan. 20, 2010

Related U.S. Application Data
(60) Provisional application No. 61/235,851, filed on Aug. 21, 2009.

(51) Int. Cl. G06Q 30/00

(52) U.S. Cl. 705/14.25

(57) ABSTRACT

An offer management system may provide an open platform capable of aggregating offers from multiple offer providers. All offers may be uploaded to the offer management system and presented to consumers via a single portal so they can easily browse, select and review all available digital offers at one time, in one place. Upon visiting a hosted website, the offer management system may interact with the consumer by displaying references to digital offers on the home page or in the navigation bar. The offer management system can display personalized content that may feature any available offers targeted specifically to the consumer based upon personal information contained in a profile for the consumer that is associated with the consumer's online account, such as a loyalty card account. Moreover, the offer management system may receive requests from the consumer to print selected offers or download selected offers to the consumer's account.

### CROSS-REFERENCE TO RELATED APPLICATIONS

This application claims the benefit of U.S. Provisional Application No. 61/235,851 filed Aug. 21, 2009, which is hereby incorporated by reference in its entirety.

This application is related to U.S. application Ser. No. ______, filed on ______, and U.S. application Ser. No. ______, filed on ______. Both related applications are incorporated herein by reference in their entirety.

### TECHNICAL FIELD

The following generally relates to a system and method for managing, displaying, distributing, integrating, and redeeming digital offers from an aggregated source.

### BACKGROUND

The advent of the Internet has revolutionized many industries, including the couponing industry. Rather than manually clipping coupons from newspapers or advertisement with a pair of scissors, consumers can store digital offers in an online account with little more than a touch of a button or a keystroke. Digital offers refer to coupons, vouchers or other incentives that exist electronically. Digital offers are subsequently redeemed by merely confirming the identity of the consumer associated with the online account. Thus, consumers no longer have to carry paper coupons with them to the store or struggle to find applicable coupons to present to a clerk at checkout.

### SUMMARY

A computer system for aggregating, managing and distributing digital offers may include at least one computer and at least one database that are in electronic communication with each other. In accordance with one or more embodiments of the present application, the computer system and its corresponding methodology may be based upon a highly referential object-oriented database that maintains several lists identifying a number of offer providers, a number of retailers, a number of users (consumers), and a number of digital offers. The digital offers may be represented as electronic coupon objects including data referencing the offer providers, retailers, and consumers, amongst other offer information details. The system may receive the number of offers from one or more of the offer providers. The system may aggregate the number of offers received from the one or more offer providers and store the aggregation of offers in the database. For each of the aggregated offers, the system may determine whether one or more designated retailers provide at least one item associated with the offer. The system may further generate a single, electronic form for displaying a number of offers from the aggregation of offers stored in the database. The single, electronic form may include one or more pages. A consumer or user may view the number of offers displayed in the electronic form on a user display for a user device, such as a personal computer, a personal digital assistant (PDA), a mobile phone, a kiosk, a global positioning system (GPS) unit, a digital television, or other similar networked, electronic device.

Prior to generating the electronic form, the aggregation of offers may be filtered to obtain a filtered aggregation of offers. Accordingly, the electronic form may be generated for displaying a number of offers from the filtered aggregation of offers. According to one or more embodiments, the aggregation of offers may be filtered by a viewing channel owner. The viewing channel owner may be a consumer packaged goods (CPG) entity, a manufacturer, a syndicated source, a retailer, an advertiser, a restaurant, or some other offer provider and/or distributor. For example, a filtered aggregation of offers may include offers associated with just one offer provider, such as a CPG entity. Accordingly, when the user accesses a viewing channel of the CPG entity, the single, electronic form may be generated for displaying a number of CPG associated offers. As another example, the aggregation of offers may be filtered by a retailer. Thus, the filtered aggregation of offers may include offers associated with the retailer (e.g., retailer offers, CPG offers for goods sold by the retailer, etc.). Accordingly, when the user accesses a viewing channel of the retailer, the single, electronic form may be generated for displaying a number of the retailer associated offers. The viewing channel may be a source website, webpage or webform associated with the viewing channel owner. Moreover, the viewing channel may correspond to banner page advertisements, digital television advertisements, mobile device advertisements, email, and the like. Additionally or alternatively, the aggregation of offers may also be filtered based on a number of business rules. For example, the business rules may apply filters corresponding to such things as user shopping preferences, user profile information, and whether items associated with the offers are stocked at a store. Other filters may be applied to the aggregation of offers prior to generating the single, electronic form for displaying the number of offers from the filtered aggregation of offers without departing from the spirit and scope of the present application.

According to one or more embodiments of the present application, the aggregation of offers may also undergo an arbitration process. For instance, the system may identify a competing offer scenario between at least two offers in the aggregation of offers. A competing offer scenario may occur when two or more offers for the same item or similar items are identified in the aggregation of offers. The system may arbitrate the competing offer scenario to determine which offer or offers to present to the user and in what order. The competing offer scenario may be arbitrated in any number of ways. For example, offers may be grouped into a number of offer groupings. Some exemplary offer groupings may include a targeted offer group, a non-targeted offer group, an exclusive offer group, a syndicated content offer group, and a non-enumerated or general offer group. Moreover, the offer groupings may be prioritized according to an offer hierarchy. Competing offers that are in different offer groupings may be arbitrated according to the offer hierarchy. Thus, the competing offer associated with the highest priority offer group may be presented to the user before a competing offer in a lower priority offer group. Competing offers that are in the same offer grouping may be arbitrated according to a set of business rules (e.g., by value or expiration date). Accordingly, the competing offer scenario may be arbitrated based on the number of offer groupings, the offer hierarchy for the number of offer groupings, and at least two offers included in the competing offer scenario to obtain at least one arbitrated offer based on the at least two offers included in the competing offer scenario. In particular, the system may identify the offer group for each of the at least two offers in the competing offer scenario and select the at least one arbitrated offer based on the offer hierarchy and the offer group for each of the at least two offers.

The offer providers may define the offer groupings and their corresponding hierarchy according to the set of business rules. Each offer provider may employ its own set of business rules. Therefore, the arbitration of a competing offer scenario may differ depending upon which viewing channel is selected by the user. If the user is viewing a retailer's website, offers may be grouped according to offer groupings defined by the retailer and competing offer scenarios may be arbitrated based on an offer hierarchy of the offer groupings as also defined by the retailer. Upon completion of the arbitration process, one or more arbitrated offers may be presented to the user via the single, electronic form. The one or more arbitrated offers that are transmitted or otherwise presented to the user may differ if the user views another viewing channel, such as another retailer's website or an offer provider's website.

As previously mentioned, the consumer or user may view a number of the aggregation of offers on a display for a user device. For example, the user may view a number of the aggregation of offers by accessing a source website, webpage or webform associated with a viewing channel owner. The system may generate a single, electronic form for displaying the number of offers from the aggregation of offers within the source website, webpage or webform. The single, electronic form may be an inline frame (“iframe”) form or one or more web services for rendering the display on the user device, such as a set of application programming interfaces (APIs).

According to one or more embodiments of the present application, the system may identify the users through a logon process. In particular, the system may prompt a user to input user information when, for example, the user is browsing a website of a viewing channel owner, such as a retailer's website. The user information may include user logon information such as a user name and password, physiological and behavioral biometric information, or the like. The system may then evaluate the user information in order to authenticate the user. The system may authorize the user based on the user information to obtain an authorization value. The process of authorizing the user may be executed using a shared computer-implemented sign-on tool. Based on the authorization value, the electronic form including the number of offers from the aggregation of offers stored in the database may be displayed. The electronic form may be displayed in a source website, webpage or webform associated with the viewing channel owner on a user device. At some point in time, the system may also receive a unique identifier from the user and associate the unique identifier with the user logon information.

Once the user is authorized based on the user information, the system may receive user-specific information corresponding to the user. The user-specific information may be received from a database that collects, accumulates, generates and/or stores the user-specific information. The system may then target the user by selecting one or more offers from the aggregation of offers to present to the user, based upon the user-specific information, to obtain one or more selected aggregated offers. The system may transmit the one or more selected aggregated offers so that they can be distributed to the user (e.g., by displaying the one or more selected aggregated offers in a source website, webpage or webform). The user-specific information may include media behavior data, purchasing behavior data, user shopping preference data, demographic data such as geographic data and the like, relating to the user. Media behavior data may relate to the user's prior or preferred methods of interaction with the offer management system (e.g., what type of user device used to access which viewing channel, etc.). Purchasing behavior data may relate to the user's prior purchases or purchasing habits. User shopping preference data may include data corresponding to the user's preferred shopping categories, products, and/or brands.

Demographic data relating to the user may include user profile information such as age, gender, race, household size, income level, educational background, marital status, employment status, home ownership status, geographic data, or the like. For instance, the system may select the one or more offers from the aggregation of offers for the user based at least in part upon the geographic data. Conversely, the system may restrict the selection of one or more offers from the aggregation of offers for the user based at least in part upon the geographic data. Geographic data may include national, regional and local geographic data relating to the user. Further, the aggregation of offers may be organized or filtered into a number of national offers, a number of regional offers, and a number of local offers. For instance, the system may select one or more national offers for the user based at least in part upon the national geographic data to obtain one or more selected national aggregated offers. Similarly, one or more regional offers may be selected based in part upon the regional geographic data to obtain one or more selected regional aggregated offers. Finally, one or more local offers may be selected for the user based at least in part upon the local geographic data to obtain one or more selected local aggregated offers. In this regard, the system may not target the user with local or regional offers that are not associated with the local or regional geographic data relating to the user.

In addition to receiving user-specific information, the system may receive selection information from the one or more offer providers. Specifically, an offer provider may provide input to the system corresponding to its marketing directives, which may align with the user-specific information. Correspondingly, the one or more selected aggregated offers may be based upon the user-specific information and the selection information received from offer providers. Alternatively, for general offers, the system may receive selection information from at least one designated retailer. The selected offers from the aggregation of offers may then be presented to the user via the single, electronic form displayed in the viewing channel accessed by the user during the logon process. For example, the user device may be operable to receive a single, electronic form for displaying a number of offers from a filtered aggregation of offers and display the single, electronic form to obtain user selected offers from the number of offers in the filtered aggregation of offers.

The user may, in turn, select one or more of the offers from the number of displayed offers displayed in the electronic form for subsequent distribution. To this end, the system may receive one or more offers selected by the user from the number of displayed offers. For instance, the electronic form may include a selection feature for each of the number of displayed offers. The system may receive selection input for the selection feature for one or more of the number of offers to obtain one or more selected offers. After receiving the selection input, the one or more selected offers may be linked to the unique identifier for the user. The unique identifier may be a consumer identifier for the user, such as a loyalty card identifier, a membership identifier, an account number, a personal identification number (PIN), a telephone number, a credit card number, a wireless identifier, or the like. In this regard, the consumer identifier may be a generated or provided character string. After receiving the selection input, the one or more selected offers may also be linked to a retail computer system and/or a retail database or dataset. It should be noted that the retail database or dataset may be included in the retail computer system. The system may also be operable to generate a single, electronic form for displaying the one or more offers selected by the user. The system may be further operable to print at least a portion of the single, electronic form or print at least one of the number of offers displayed on the electronic form.

According to one or more embodiments of the present application, the computer system may include an interface for communicating between the computer and one or more retail systems to provide real-time updates of offer information and/or retail offer information. To this end, the system may receive offer information including the unique identifier of the user and one or more unredeemed offers associated with the unique identifier. The system may also receive retail offer information including a specified identifier for each of the one or more retail systems. Correspondingly, the system may associate the unique identifier, the specified identifier and the one or more unredeemed offers so that the user is capable of redeeming the one or more unredeemed offers based on the specified identifier. Similarly, the system may also receive offer information including the unique identifier of a user and instructions to withdraw one or more offers associated with the unique identifier. In this regard, the system may associate the unique identifier, the specified identifier and the instruction to withdraw the one or more offers so that the user is incapable of redeeming the one or more withdrawn offers based on the specified identifier. The specified identifier may identify a retailer of each of the one or more retail systems. Moreover, each of the one or more retail systems may include a retail database, such as a targeting database, a loyalty database, and a POS database. A loyalty database may include a plurality of unique consumer identifiers.

Through the interface, the retail system may receive offer information from the computer. According to one or more embodiments, the offer information may be redemption offer information. The offer information may include a unique identifier for the user. The retail system may determine a validity and activity status for the unique identifier. Based on the validity status and the activity status, the retail system may transmit the identity of the user associated with the unique identifier to the computer. Correspondingly, the system may receive user information including the identity of the user associated with the unique identifier of the user. The unique identifier may be the unique consumer identifier.

Offers selected by the user may be redeemed at a POS location (e.g., a retailer location). To this end, the retail system may receive the unique identifier of the user and identifying information relating to a number of items to be purchased by the user at the retailer location. The retail system may also receive offer information including the unique identifier of the user and one or more unredeemed offers for the number of items to be purchased associated with the unique identifier. The identifying information relating to the number of items to be purchased by the user may be compared with the one or more unredeemed offers to obtain a number of matched items. The retail system may transmit each of the number of matched items and the associated unique identifier, and information identifying the retailer to the computer as updated offer information. Accordingly, the computer may be updated with the updated offer information in real-time. Moreover, feedback based on the updated offer information may be provided to the offer provider, the retailer or the user.

### BRIEF DESCRIPTION OF THE DRAWINGS

The accompanying drawings, which are incorporated in and constitute a part of the specification, illustrate one or more embodiments of the present invention. These drawings, together with the general description given above and the detailed description of the one or more embodiments given below, are intended to explain the principles of the invention and do not limit its scope.

FIG. 1 is a simplified, exemplary block diagram depicting a computer-implemented system for managing digital offers according to one or more embodiments of the present application;

FIG. 2 is a simplified, exemplary workflow diagram illustrating an offer management workflow according to one or more embodiments of the present application;

FIG. 3 is a simplified, exemplary process flowchart depicting a method for managing digital offers according to one or more embodiments of the present application;

FIG. 4 is a simplified, exemplary data flow diagram relating to a digital offer input and registration process according to one or more embodiments of the present application;

FIG. 5 is a simplified, exemplary data flow diagram relating to a digital offer targeting process according to one or more embodiments of the present application;

FIG. 6 is a simplified, exemplary data flow diagram relating to a digital offer selection process according to one or more embodiments of the present application;

FIG. 7 is a simplified, exemplary data flow diagram relating to a digital offer management and communication process according to one or more embodiments of the present application;

FIG. 8 is a simplified, exemplary data flow diagram relating to a digital offer redemption process according to one or more embodiments of the present application;

FIG. 9 is a simplified, exemplary data flow diagram relating to a digital offer settlement process according to one or more embodiments of the present application;

FIG. 10a is a simplified, exemplary diagram of an electronic form according to one or more embodiments of the present application; and

FIG. 10b is a simplified, exemplary diagram of another electronic form according to one or more embodiments of the present application.

### DESCRIPTION OF EMBODIMENTS

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for teaching one skilled in the art to variously employ the one or more embodiments of the present invention.

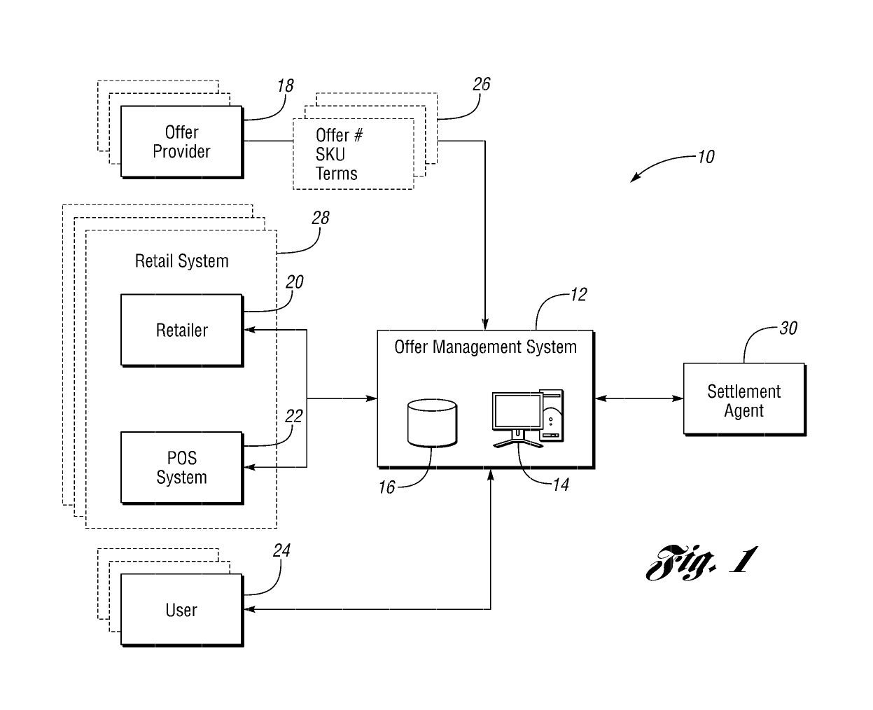

One apparatus embodiment for implementing one or more embodiments of the present application is illustrated in FIG. 1. It should be readily understood by those of skill in the art that the apparatus may vary significantly from the example shown, based on the rapid advances in technology that are ongoing in this field.

FIG. 1 illustrates a simplified, exemplary diagram of a networked computer system 10 for managing digital offers (e.g., electronic coupons). The system 10 may generally include one or more integrated databases, application servers, and client components that facilitate digital offer creation, collection, aggregation, management, distribution, redemption and settlement operations. The system 10 may be scalable to potentially handle a high volume of digital offer transactions in a network comprising both wide area networks (e.g., the Internet) and local area networks (e.g., local in-store POS networks). The system 10 may be supported by a tiered client/server application environment.

At the core of the computer system 10 may be a digital offer management system 12, which may include at least one computer 14 and at least one database 16 in communication with each other. The at least one computer 14 may have a central processing unit (CPU) for executing machine instructions and a memory for storing machine instructions that are to be executed by the CPU. The offer management system 12 may include or otherwise cooperate with one or more computer applications (not shown). Each of the number of computer applications may be one or more computer subsystems using a networked client-server database architecture. The offer management system may also cooperate with a number of clients, which may also include one or more computer subsystems running one or more computer applications using a networked client-server database, or a manual system of sourced information, or a combination thereof. The offer management system 12 may provide support for and interact with the client application servers. Several client types may communicate with the offer management system 12. For example, the offer management system 12 may communicate electronically with a number of offer providers 18, a number of retailers 20, a number of point of sale (POS) systems 22, and a number of users (consumers) 24. According to one or more embodiments of the present application, one or more of the clients may also be in electronic communication with each other. Information may be transmitted and received throughout the computer system 10 via this tiered client/server application network.

Offer providers 18 may be responsible for creating and defining a number of digital offers 26. An offer provider 18 may refer to any source of digital offers. Exemplary offer providers may include a consumer packaged goods (CPG) entity, a manufacturer, a retailer, a service provider, a syndicated source, an advertiser, a restaurant, or the like. A retailer 20 may refer to any entity that sells goods directly to users. It should be noted that the term retailer, as used herein, may also refer to service providers, restaurants, or other entities that sell directly to users. As described above, a retailer 20 may also be an offer provider since retailers often generate coupons for use in their own stores. A POS system 22 may refer to a network operated by a computer subsystem and linked to several POS terminals (e.g., checkout registers) located at one or more retailer outlets (POS locations). Thus, each retailer 20 may be associated with a corresponding POS system 22. Although shown as separate clients, because they may behave as such at times, a retailer 20 and a corresponding POS system 22 may form at least a part of a retail system 28. A user 24 may refer to any consumer that participates in a digital offer program by receiving offers electronically for subsequent redemption at a POS location.

The computer system 10 may also include a settlement agent 30 (e.g., a clearing house). The settlement agent 30 may facilitate and manage the clearing and settlement process of redeemed digital offers. The settlement agent 30 may be an entity independent from the offer management system 12 as depicted in FIG. 1.

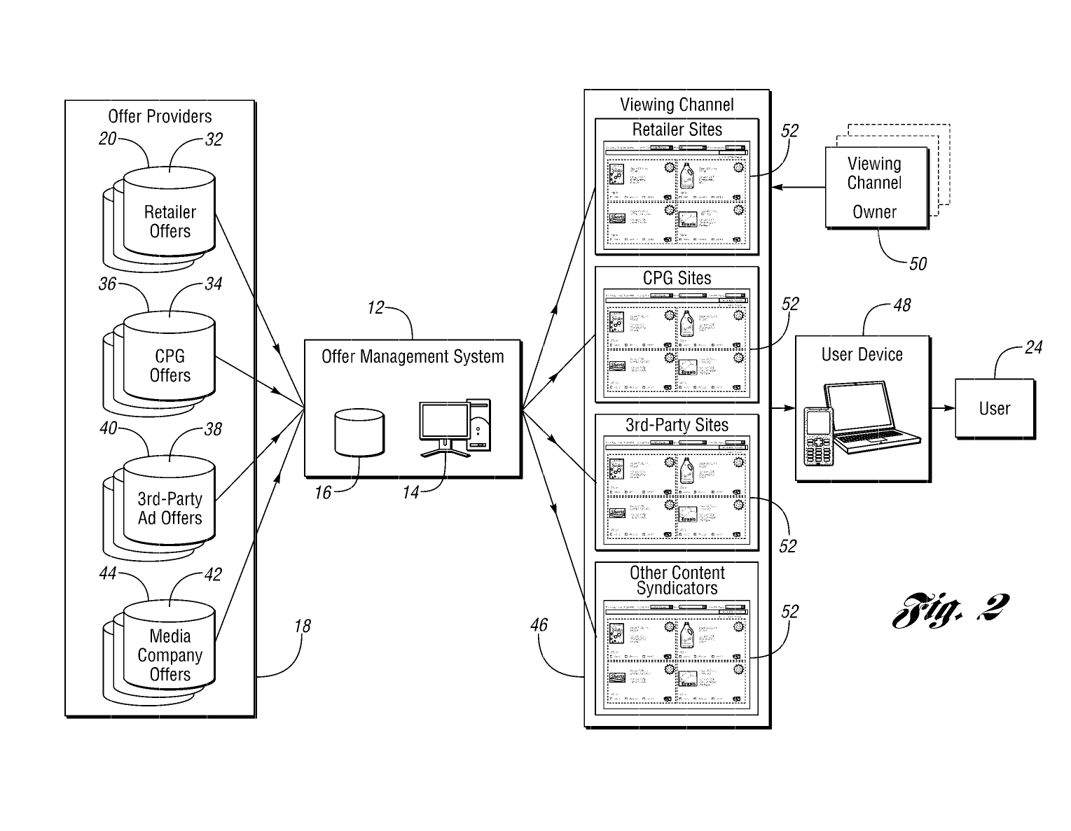

FIG. 2 is a simplified, exemplary workflow diagram illustrating a portion of an offer management workflow according to one or more embodiments of the present application. As seen therein, the number of digital offers 26 may be transmitted from a number of offer sources (i.e., the offer providers 18) to the offer management system 12. The number of digital offers may be a number of retailer offers 32 transmitted from the number of retailers 20, a number of CPG offers 34 transmitted from a number of CPG entities 36, a number of advertiser offers 38 transmitted from a number of third-party advertisers 40, a number of media company offers 42 transmitted from a number of media companies 44, or the like. As previously mentioned, the digital offer management system 12 may be based upon a highly referential object-oriented database that maintains several lists identifying the offer providers 18, the retailers 20, the users 24, and the number of digital offers 26. The digital offers 26 may be represented as electronic coupon objects that may include data referencing, at one time or another, the offer providers 18, the retailers 20, and the users 24, amongst other offer information details (e.g., offer activation and deactivation dates, offer start and expiration dates, offer images and text, item codes, offer terms, etc.). As shown, the offer management system 12 may receive the digital offers 26 from the offer providers 18 where they may be aggregated and stored in the database 16. The digital offers 26 may then be distributed to a number of offer destinations or viewing channels 46 for display to the number of users 24. The viewing channels 46 may include a hosted website, webpage or webform associated with a number of viewing channel owners 50, such as a retailer, a CPG entity, a third-party advertiser, a syndicated source, or other offer provider. Moreover, the viewing channels may also correspond to banner page advertisements, digital television advertisements, email, mobile device advertisements (e.g., SMS/MMS), and the like.

The users 24 may view a number of the aggregated offers on a display (not shown) for a user device 48, such as a personal computer, a personal digital assistant (PDA), a mobile phone, a kiosk, a global positioning system (GPS) unit, a digital television, or other similar networked, electronic device. It should be noted that the user device 48 might not necessarily be a user-owned device. Rather, the user device 48 may be any device that a user can interface with to view the digital offers 26. As illustrated in FIG. 2, the user 24 may view the number of aggregated offers by accessing a viewing channel 46 associated with a viewing channel owner 50 (e.g., a source website, webpage or webform associated with a retailer). The offer management system 12 may generate a single, electronic form 52 for displaying the number of offers 26 from the aggregation of offers within the viewing channel 46. The single, electronic form 52 may include one or more pages of the aggregated digital offers. Moreover, the single, electronic form 52 may be an inline frame (“iframe”) form or one or more web services for rendering the display on the user device, such as a set of application programming interfaces (APIs). As is known in the art, an iframe is an HTML construct that embeds external objects into an HTML document so that the embedded data is displayed inside a sub-window of a browser. The external objects may include other HTML documents.

The aggregation of offers may be filtered prior to generating the single, electronic form to obtain a filtered aggregation of offers. According to one or more embodiments, the aggregated offers may be filtered according to the viewing channel owner. For instance, the filtered aggregation of offers may include a number of digital offers associated with just one offer provider 18, such as a CPG entity. Accordingly, when a user 24 accesses the CPG entity's website, the single, electronic form may be generated for displaying a number of CPG associated offers. As another example, the aggregation of offers may be filtered by a retailer 20. Thus, the filtered aggregation of offers may include offers associated with the retailer (e.g., retailer offers, CPG offers for goods sold by the retailer, etc.). Accordingly, when a user 24 accesses the retailer's website, the single, electronic form may be generated for displaying a number of the retailer associated offers. Additionally or alternatively, the aggregation of offers may also be filtered based on a number of business rules. For example, the business rules may apply filters corresponding to such things as user shopping preferences, user profile information, and whether items associated with the offers are stocked at a store. Of course, other filters may be applied to the aggregation of offers prior to generating the single, electronic form for displaying the number of offers from the filtered aggregation of offers without departing from the spirit and scope of the present application.

According to one or more embodiments of the present application, the aggregation of offers may also undergo an arbitration process. For instance, the offer management system 12 may identify a competing offer scenario between at least two offers in the aggregation of offers. A competing offer scenario may occur when two or more offers for the same item or similar items are identified in the aggregation of offers. For instance, a competing offer scenario may be identified between at least two offers for the same type of product made by different manufacturers. The offer management system 12 may arbitrate the competing offer scenario to determine which digital offer or offers to present to the user 24 and in what order. The competing offer scenario may be arbitrated in any number of ways. For example, offers may be grouped into a number of offer groupings. Some exemplary offer groupings may include a targeted offer group, a non-targeted offer group, an exclusive offer group, a syndicated content offer group, and a non-enumerated or general offer group. Moreover, the offer groupings may be prioritized according to an offer hierarchy. Competing offers that are in different offer groupings may be arbitrated according to the offer hierarchy. Thus, the competing offer associated with the highest priority offer group may be presented to the user 24 before a competing offer in a lower priority offer group. Competing offers that are in the same offer grouping may be arbitrated according to a set of business rules (e.g., by value or expiration date). Accordingly, the competing offer scenario may be arbitrated based on the number of offer groupings, the offer hierarchy for the number of offer groupings, and at least two offers included in the competing offer scenario to obtain at least one arbitrated offer based on the at least two offers included in the competing offer scenario. In particular, the offer management system 12 may identify the offer group for each of the at least two offers in the competing offer scenario and select the at least one arbitrated offer based on the offer hierarchy and the offer group for each of the at least two offers.

The offer providers 18 may define the offer groupings and their corresponding hierarchy according to a number of business rules. Each offer provider 18 may employ its own business rules. Therefore, the arbitration of a competing offer scenario may differ depending upon which viewing channel 46 is selected by the user 24. If the user 24 is viewing a retailer's website, offers may be grouped according to offer groupings defined by the retailer 20. Further, competing offer scenarios may be arbitrated based on an offer hierarchy of the offer groupings as also defined by the retailer 20. Upon completion of the arbitration process, one or more arbitrated offers may be presented to the user 24 via the single, electronic form 52. The one or more arbitrated offers that are transmitted or otherwise presented to the user 24 may differ if the user views another viewing channel 46, such as another retailer's website or an offer provider's website.

According to one or more embodiments, the offer management system 12 may identify a user 24 through a logon process. As one example, the user 24 may be a registered customer of a retailer 20. In particular, the user 24 may be a member of the retailer's loyalty program (e.g., frequent shopper program, club, etc.). As a member of the retailer's loyalty program, the user 24 may have an online account associated with the retailer's loyalty program. The retailer's loyalty program may be maintained by the retail system 28 associated with the retailer 20. In order to maintain a seamless consumer experience, and avoid multiple log-on pages, the retailer 20 and the offer management system 12 may share the user's identity. The user 24 may be given access to the digital offers aggregated by the offer management system 12 by simply logging into a website hosted by the retailer 20. The offer management system 12 may provide a single sign-on tool that may securely link and exchange the necessary customer identity information between the retailer and the offer management system 12. Single sign-on (SSO) is a property of access control of multiple, related, but independent software systems. Accordingly, the SSO tool may mitigate customer frustration and inconvenience caused by being transferred to a separate website requiring an additional login and potentially different login credentials. The retail system 28 may also share user-specific information associated with the user 24. The user-specific information may include information provided by the user 24 upon registering for the retailer's loyalty program or collected by the retail system 28 over time.

Once the user's identity is authenticated, the offer management system 12 may generate the single, electronic form 52 for displaying a number of targeted offers from the aggregation of offers. The targeted offers may be digital offers selected by the offer management system 12 based upon the user-specific information corresponding to the user 24. The user-specific information may include media behavior data, purchasing behavior data, user shopping preference data, and the like, relating to the user 24. Media behavior data may relate to the user's prior or preferred methods of interaction with the retailer's loyalty program (e.g., what type of user device 48, which viewing channel 46, etc.). Purchasing behavior data may relate to the user's prior purchases or purchasing habits. User shopping preference data may include data corresponding to the user's preferred shopping categories, products, and/or brands. The offer management system 12 may also select one or more offers from the aggregation of offers for the user 24 based at least in part upon demographic data relating to the user. Conversely, the offer management system 12 may restrict the selection of one or more offers from the aggregation of offers for the user based at least in part upon the demographic data. Demographic data relating to the user may include user profile information such as age, gender, race, household size, income level, educational background, marital status, employment status, home ownership status, geographic data, or the like. Geographic data may include national, regional and local geographic data relating to the user. In this regard, the offer management system 12 may avoid presenting local or regional offers that are not associated with the local or regional geographic data relating to the user.

In addition to receiving user-specific information, the offer management system 12 may receive selection information from the one or more offer providers 18. Specifically, an offer provider 18 may provide input to the system corresponding to its marketing directives, which may align with the user-specific information. For instance an offer provider 18 may create rules or provide criteria around which an offer is based. These rules or criteria may not be altered or overridden by a retailer 20. Correspondingly, the one or more selected aggregated offers may be based upon the user-specific information and the selection information received from offer providers 18. Alternatively, an offer provider 18 may generate general offers without specific consumer targets. A retailer 20 may elect to display the general offers without any targeting directives. Alternately, the retailer 20 may apply its own specific criteria for targeting users with the general offers. The retailer 20 may be inclined to target an otherwise general offer generated by an offer provider 18 to users most likely to purchase an item associated with the offer in order to increase the offer's redemption rate. Accordingly, the offer management system 12 may receive selection information from the retailer 20, and the one or more selected, aggregated offers may be based upon the user-specific information and the selection information received from the retailer 20.

The user 24 may select one or more of the digital offers displayed on the user device 48, via the single, electronic form 52, for subsequent redemption. Offers selected by the user 24 may be redeemed at a POS location (e.g., a retailer location associated with the retailer 20) by presenting a unique identifier associated with the user's loyalty account at a POS terminal. Correspondingly, the offer management system 12 may communicate in real-time with the POS system 22 associated with the retailer to facilitate offer redemption. As previously mentioned, the POS system 22 may be part of the retail system 28.

Although the foregoing describes an example in which a user is a registered member of a retailer's loyalty program, the system and method described herein may be equally applicable to other online coupon systems. In this regard, the user 24 may have an online account associated with another viewing channel owner 50, such as a CPG entity or other syndicated coupon distributor in connection with the offer management system 12. According to one or more embodiments, the online accounts may be associated with each other via the offer management system 12. For example, the retailer 20 may be affiliated with the CPG entity as a business partner. The CPG entity and the offer management system 12 may share the user's identity. The user 24 may be given access to the digital offers aggregated by the offer management system 12 by simply logging into a website hosted by the CPG entity. Correspondingly, the offer management system 12 may generate a single, electronic form 52 displaying a number of CPG associated offers that may be redeemed at a POS location of the retailer 20. The user 24 may, in turn, select a number of digital offers from the CPG associated offers for subsequent redemption at the affiliated retailer. According to one or more embodiments, the logon credentials for the user 24 may be the same for both the retailer 20 and the CPG entity as facilitated by the SSO tool. According to one or more other embodiments, the CPG entity may be affiliated with several retailers. Moreover, a unique identifier associated with the user's online CPG account may be presented at a POS location for redeeming a number of selected CPG associated offers. Alternately, the user's CPG account may be linked to the unique identifier associated with the user's retailer account. Accordingly, the user 24 may present the unique identifier for the retailer account at the POS location in order to redeem the number of CPG associated offers selected at the website hosted by the CPG entity.

As described herein, the offer management system may provide an open platform capable of aggregating offers from multiple offer providers 18 including retailers, retailer partners, CPG entities, third-party offer providers, advertisers, syndicated sources, media companies, and the like. All offers may be uploaded to the offer management system 12 and presented to users 24 via a single portal so they can easily browse, select and review all available digital offers at one time, in one place on, for example, a viewing channel owner's website. Business rules may guide the presentation order for all offers regardless of source. Upon visiting the viewing channel owner's website, the offer management system 12 may interact with the user 24 by displaying references to digital offers on the home page or in the navigation bar. As a user navigates the website to view the digital offers, the offer management system 12 may display a single page showing all digital offers, regardless of source, available for redemption at retailers' stores. The offer management system 12 may allow the user 24 to browse non-targeted national offers and content without logging into the viewing channel owner's website. However, the offer management system 12 may preclude users from accessing or selecting digital offers for printing, downloading to a card, or downloading to a mobile device unless the user logs into the viewing channel owner's website. This may ensure that the offer management system 12 can identify the user 24 and prevent duplicate redemption situations (e.g., the user may be unable to both print and download to card the same digital offer). Once logged into the viewing channel owner's website, the offer management system 12 may display content similar to that displayed when the user 24 is logged off. However, upon identifying the user 24 through the logon process, the offer management system 12 can display personalized content that may feature any available offers targeted specifically to the user 24 based upon personal information contained in a profile for the user that is associated with the user's online account, such as a loyalty card account. Moreover, the offer management system 12 may receive requests from the user 24 to print selected offers or download selected offers to the user's account. For instance, the offer management system 12 may receive requests to download selected offers to a loyalty card or mobile device associated with a loyalty account of the user 24.

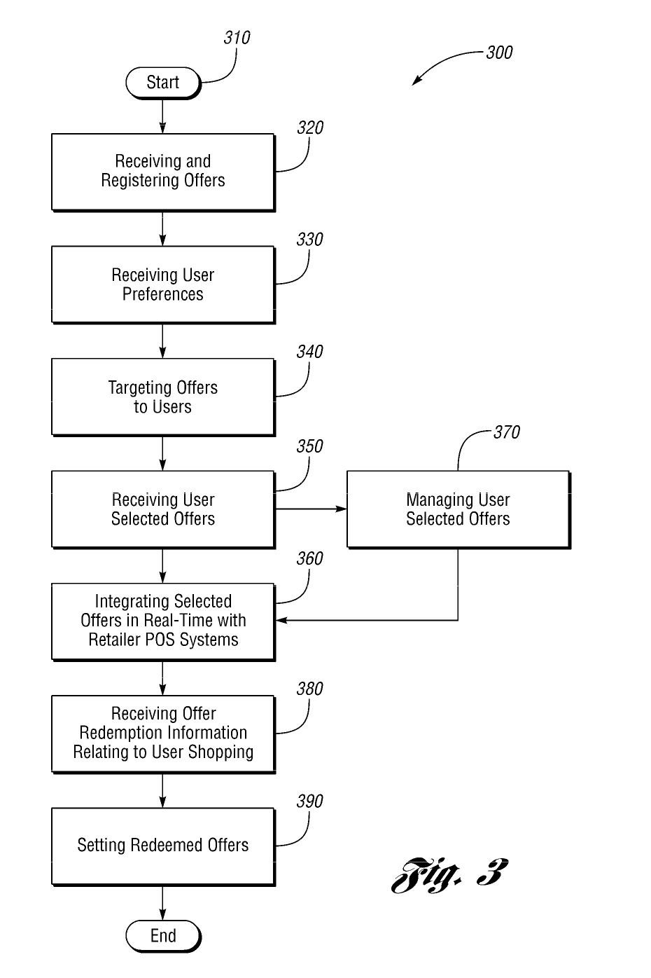

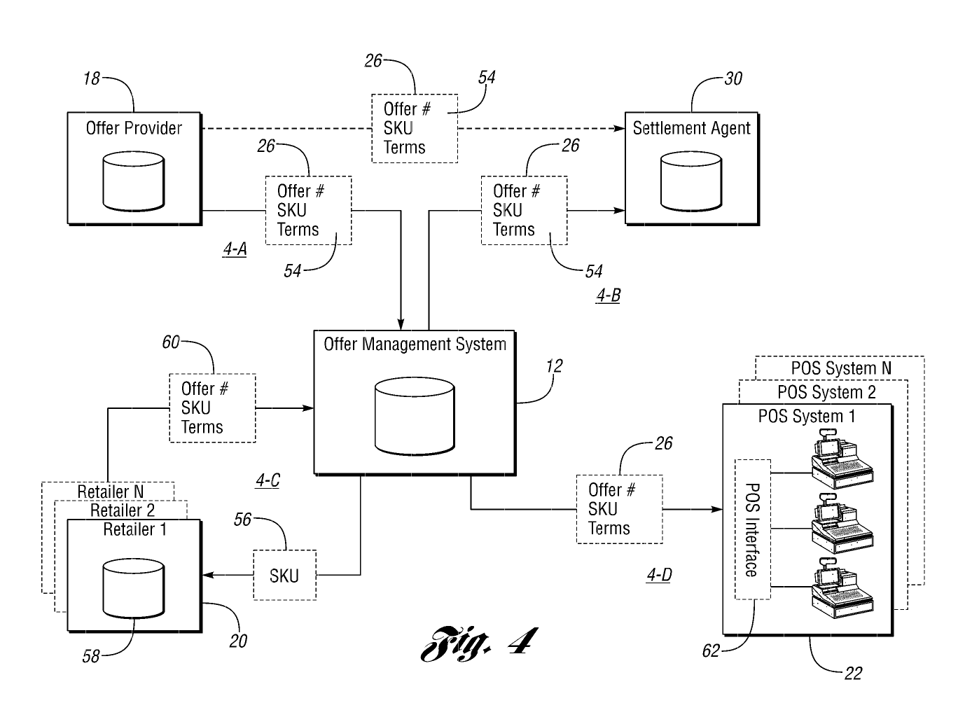

FIG. 3 is a simplified, exemplary process flowchart 300 depicting a method for managing digital offers according to one or more embodiments of the present application. It should be readily appreciated that the steps may be modified, omitted, and/or added to depending on the implementation of one or more embodiments. The flowchart 300 in FIG. 3 provides a general overview of a process for managing a number of digital offers from an aggregated source. The steps in the flowchart are described in greater detail below with specific reference to FIGS. 4-9, which collectively illustrate a life cycle of a single digital offer by way of data flow diagrams showing the exchange of information between the various system components.

With reference now to FIG. 3, step 310 provides an entry to the method. At step 320, a number of digital offers 26 may be received by the offer management system 12 and registered with the settlement agent 30. The digital offers 26 may be received from one or more of the offer providers 18. The offer management system 12 may aggregate the digital offers 26 and store them in the database 16. The offers may also be arbitrated and filtered in the manner previously described. The offer management system 12 may also communicate offer information corresponding to the digital offers 26 to one or more retail systems 28 and receive retail offer information from the retail systems to obtain updated offer information. The updated offer information may also be communicated to each POS system 22 associated with the one or more retail systems 28.

The offer management system 12 may receive user-specific information such as offer communication preferences from the number of users 24, as provided at step 330. For instance, users 24 registered with an online couponing program associated with the offer management system 12, such as a retailer loyalty program, may specify the manner in which digital offer information is communicated to the user 24. The offer communication preferences may relate to digital offer notification and alert media preferences, selected digital offer download preferences, and the like.

As previously mentioned, once the digital offers 26 are received and registered by the offer management system 12, they may be aggregated, arbitrated, filtered and distributed to the users 24. The offer management system 12 may target particular users based upon user-specific information, as provided at step 340. Accordingly, the digital offers 26 may be selected based on the user-specific information to obtain a number of targeted offers. A particular user may be identified by the offer management system 12 through the aforementioned logon process. The offer management system 12 may then generate the single, electronic form 52 for displaying the targeted offers to the user 24.

After presenting the targeted offers to the user 24, the offer management system 12 may receive data corresponding to digital offers selected by the user 24, as provided at step 350. For instance, the user 24 may select digital offers he or she intends to redeem at a POS location. The selected offers may be save to the user's account, such as the user's loyalty account. In order for the redemption process to run smoothly and transparently, the digital offers selected by the user may be communicated to a corresponding POS system 22 for real-time integration, as provided at step 360. In addition to selecting offers for later redemption, the user 24 may want to manage the digital offers the user has selected, as provided at step 370. Correspondingly, the offer management system 12 may facilitate user management of the selected offers. This may include withdrawing or removing digital offers from the user's account that the user no longer wishes to redeem. Furthermore, the user 24 may choose, and the offer management system 12 may determine, the manner in which the user 24 intends to redeem offers at a POS location. For instance, the user 24 may choose to download the selected offers to a card associated with the user's account, download the selected offers to a mobile device, or print the selected offers. Updated offer information corresponding to the user's management choices may also be communicated to the corresponding POS system 22 for real-time integration, as provided at step 360.

At step 380, the offer management system 12 may receive offer redemption information relating to consumer shopping transactions at a POS location. The offer redemption information may be received by from the POS system 22 via a POS terminal. Specifically, the user 24 may shop in person at a store of the retailer 20 and purchase a number of items at the POS location. The real-time POS integration with the offer management system 12 may allow the user 24 to redeem offers selected online in advance for in-store purchases at the POS. Correspondingly, the user 24 may provide the unique identifier associated with the user's account at the POS terminal. One or more purchased items may be matched with digital offers saved to the user's account. The user 24 may redeem the matching digital offers, and the POS system 22 may communicate POS transaction information including offer redemption information to the offer management system 12. Once the user 24 has redeemed a digital offer at a POS location, the offer management system 12 may facilitate or assist in processing, clearing and settling the redeemed offers based on the POS transaction information, as provided at step 390. The offer settlement process may prevent redundant transactions and facilitate payment.

Referring now to FIGS. 4-9, a series of data flow diagrams are shown that illustrate a life cycle of a single digital offer 26. A detailed understanding of the system 10 and method described herein may be provided by way of the data flow diagrams, which depict the exchange of information between the various system components. Although FIGS. 4-9 and the accompanying description illustrate the life cycle of a single digital offer, one or more of the aspects disclosed herein are applicable to the aggregation, management, distribution, redemption and settlement of a number of digital offers.

With specific reference to FIG. 4, a simplified, exemplary data flow diagram corresponding to the offer input and registration process, referenced at step 320 in FIG. 3, is illustrated in accordance with one or more embodiments of the present application. As seen therein, the life cycle of a digital offer may begin when an offer provider 18 generates a digital offer 26 through an offer provider application (not shown). The offer provider 18 can define the digital offer 26 by assigning it offer information 54. As previously described, the digital offer 26 may be represented as an electronic coupon object including metadata and other electronic data corresponding to the offer information 54. In particular, the offer information 54 may include an offer number, an item code (e.g., a stock keeping unit (SKU), a universal product code (UPC), etc.) corresponding to the item or items to which the digital offer applies, and terms of the offer (e.g., the offer value, expiration date, etc.). The offer information 54 may also include offer images and text associated with the digital offer 26, as well as an offer provider identifier identifying the offer source. Once the digital offer 26 is defined and generated, the offer provider 18 may transmit the digital offer to the offer management system 12 (4-A). Specifically, the offer provider 18 may transmit the electronic coupon object representing the offer containing the offer information 54. The offer management system 12 may receive the digital offer 26 and store it in the database 16 along with other digital offers that have been aggregated by the offer management system 12. The offer management system 12 may also transmit the digital offer 26 to the settlement agent 30 (4-B). Alternatively, the offer provider 18 may transmit the digital offer 26 to the settlement agent 30 directly. Upon receipt of the digital offer 26 at the settlement agent 30, the digital offer may be registered with the settlement agent to prepare for clearing, fraud prevention and settlement activities.

The digital offer 26 received by the offer management system 12 may be qualified at one or more designated retailers 20 as a stocked product (4-C). Specifically, the offer management system 12 may determine whether a retailer 20 stocks the item or items to which the digital offer 26 applies by transmitting the item code(s) 56 contained in the offer information 54 to a number of retailers 20. In particular, the item code may be transmitted to the retail system 28 associated with each of the number of retailers 20. The item code 56 may then be checked against an item master 58 for each of the number of retailers 20. As is known in the art, the item master 58 is a database that contains a master list of items that the retailer carries. If a particular retailer does not carry the item to which the digital offer 26 applies, then the digital offer may not be associated with the particular retailer. As a result, the digital offer 26 may not be subsequently presented to users for redemption at the particular retailer. On the other hand, should the particular retailer carry the item associated with the item code 56, retailer information 60 may be returned to the offer management system 12 indicating that the particular retailer stocks the item to which the digital offer applies. The retailer information 60 may include a retailer identifier corresponding to the particular retailer. Correspondingly, the offer management system 12 may associate the digital offer 26 with the retailer identifier for all retailers that carry the item to which the digital offer applies. Specifically, the offer management system 12 may update the offer information 54 corresponding to the digital offer 26 with the retailer identifier. The offer management system 12 may qualify the digital offer 26 at a particular retailer 20 at a regional or local level. For instance, if the particular retailer 20 is a relatively large retail chain, the item to which the digital offer 26 applies may be checked against an item master 58 corresponding to retailer stores in the retail chain in a regional or local area. The offer management system 12 may then check the item against the item master corresponding to retailer stores in the retail chain in a different regional or local area. To this end, the retailer information 60 returned to the offer management system 12 may also include a store identifier corresponding to one or more retailer stores that stock the item to which the digital offer 26 applies in the particular regional or local area. Alternately, the retailer identifier itself may specify the particular retailer stores.

The digital offer 26 along with the updated offer information 54 may then be transmitted to the POS systems 22 for the participating retailers in which the digital offer was qualified as a stocked product (4-D). The digital offer 26 may be registered with the POS systems 22 so that the validity of the digital offer may be ascertained, as well as the time frame for which the digital offer is valid, at each POS location when a user later attempts to redeem the digital offer. Correspondingly, the computer system 10 may include a POS interface 62 for facilitating communication between the offer management system 12 and each POS system 22. The POS interface 62 may be a web service provided by the offer management system 12. Alternately, the POS interface may be an API or XML-based file.

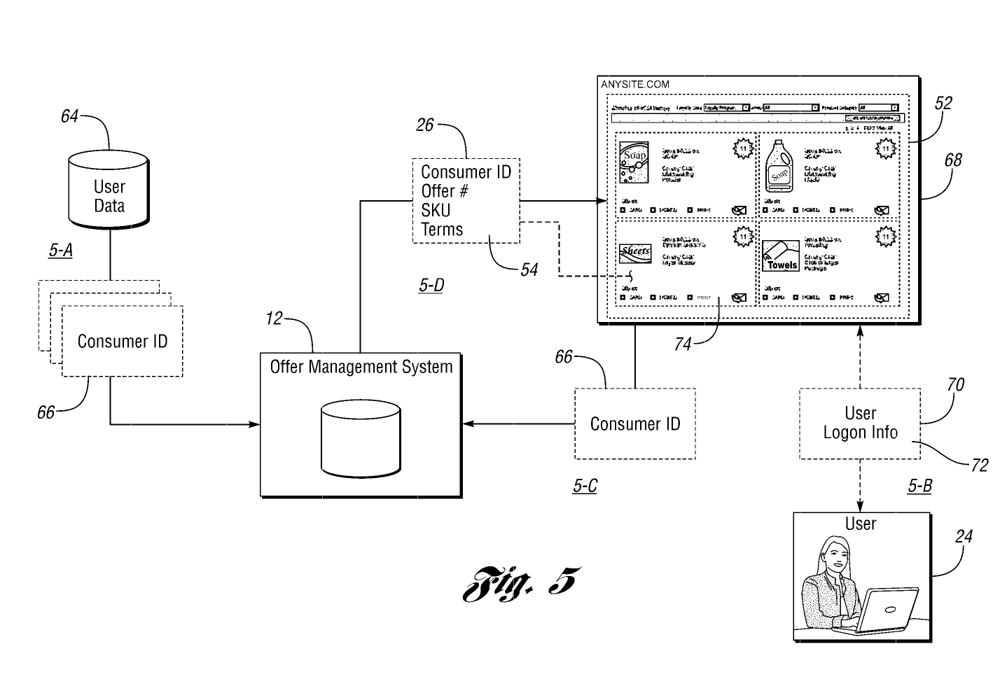

Referring now to FIG. 5, a simplified, exemplary data flow diagram corresponding to the targeting process, referenced at step 340 in FIG. 3, is illustrated in accordance with one or more embodiments of the present application. As seen therein, the computer system 10 may include a user database 64 containing user-specific information 66 for a number of users 24. The user-specific information 66 may include media behavior data, purchasing behavior data, user shopping preference data, demographic data such as geographic data, and the like relating to the number of users 24. As previously mentioned, media behavior data may relate to the users' prior or preferred methods of interaction with the offer management system 12 (e.g., mobile phone, website, etc.). Purchasing behavior data may relate to the users' prior purchases or purchasing habits. User shopping preference data may include data corresponding to the users' preferred shopping categories, products, and/or brands. Demographic data relating to the user 24 may include user profile information such as age, gender, race, household size, income level, educational background, marital status, employment status, home ownership status, geographic data, or the like. Geographic data may include national, regional and local geographic data relating to the users 24. The user database 64 may comprise one or more databases containing the user-specific information 66 (e.g., a purchase history database that collects and records purchasing transactions for the users 24). Furthermore, the user database 64 may be an integrated component of the offer management system 12 or a part of a computer subsystem external to the offer management system 12. For example, the user database 64 may be associated with a particular retail system 28. In this regard, the offer management system 12 may communicate with several and aggregate information from user databases 64.

The user-specific information 66 for each user 24 may be associated with a unique identifier. The unique identifier may be a consumer identifier that uniquely identifies a particular user 24 within the offer management and/or retailer systems. For instance, the consumer identifier may be a loyalty card identifier, a membership identifier, an account number, a personal identification number (PIN), a telephone number, a credit card number, a wireless identifier, or the like. The consumer identifier may be a generated or provided character string. The offer management system 12 may receive the user-specific information 66 corresponding to the users 24, each identified by the consumer identifier, from the user database (5-A). The offer management system 12 may determine which users 24 to target with the digital offer 26 based on the user-specific information 66 applied to predetermined methods or formulas. Accordingly, the digital offer 26 may be associated with a number of consumer identifiers based on the user-specific information 66.

A particular user 24 may browse a website 68 hosted by a viewing channel owner 50, such as that of a retailer or CPG entity. The user 24 may view a number of non-targeted, national offers without logging on to the website 68. However, if the user 24 wants to select offers for subsequent redemption, the user may be prompted to input user information 70. As previously described, the particular user 24 may logon to the website 68 via a computer-implemented sign-on tool (5-B). Accordingly, the user information 70 may include user logon information 72. The user logon information 72 may be a user name and password, physiological or behavioral biometric information, or the like. The user logon information 72 may be associated with the consumer identifier for the user 24 so that the user's identity may be obtained. In order to maintain a seamless consumer experience, and avoid multiple log-on pages, the viewing channel owner 50 and the offer management system 12 may share the user's identity. Correspondingly, the user's identity may be authenticated and the associated consumer identifier communicated to the offer management system 12 (5-C). Validating the user's identity may authorize the user 24 to receive the digital offer 26. Accordingly, an authorization value may be obtained based on the user information 70. Further, the offer management system 12 may generate a single, electronic form 52 for displaying the digital offer 26 to the user 24 based on the authorization value (5-D). For example, the offer management system 12 may join the digital offer 26 associated with the consumer identifier with the offer images and metadata corresponding to the offer information 54 to produce an iframe 74 that delivers the digital offer 26 to the user 24 in the single, electronic form 52 displayed on the website 68.

In this regard, the offer management system 12 may provide a user interface that blends into the viewing channel owner's website 68. The user interface can allow the user 24 to interact with the offer management system 12 seamlessly without appearing to leave the viewing channel owner's website 68. The user interface may provide a look and feel consistent with the viewing channel owner's website 68 and may maintain consistent menus and site navigation. In this regard, the user 24 may be unaware that he or she is interacting with another website in addition to the viewing channel owner's website 68. The user interface or portal may be branded and hosted on the viewing channel owner's website 68 and provides single sign-on so that the user 24 may access the digital offer 26 just as easily as he or she engages with other content on the viewing channel owner's website 68.

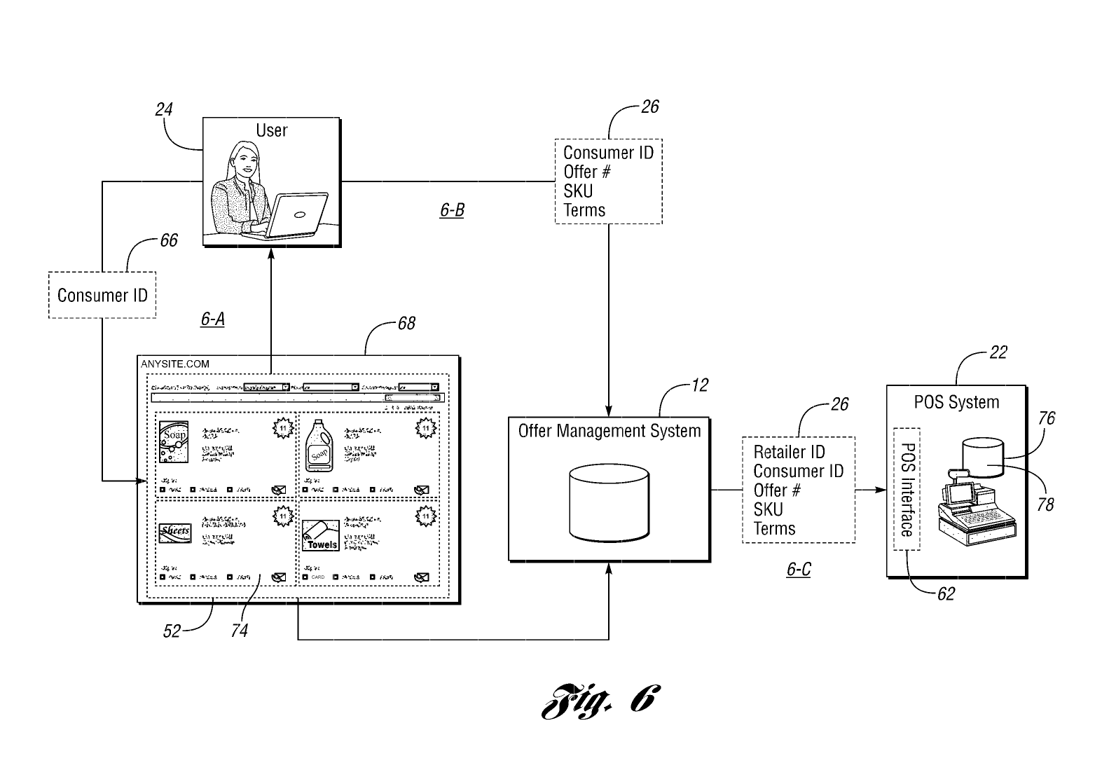

Referring now to FIG. 6, a simplified, exemplary data flow diagram corresponding to the user offer selection process, referenced at step 350 in FIG. 3, is illustrated in accordance with one or more embodiments of the present application. As seen therein, an authorized user 24, authenticated via the logon process, may browse the viewing channel owner's website 68 (e.g. a retailer's website) and select the digital offer 26 displayed in an iframe 74 of the single, electronic form 52 (6-A). The website 68 may then be updated to show that the user 24 has selected the digital offer 26. Correspondingly, page updates may be received by the offer management system 12. Moreover, upon user selection, the digital offer 26 may be associated with the consumer identifier and the retailer identifier, and the associations may be stored in the database as a selected digital offer (6-B). Additionally, the selected digital offer 26 associated with the consumer identifier and the retailer identifier may be transmitted to the corresponding POS system 22 so the POS integration may be invoked in real-time (6-C). Accordingly, the POS system 22 may be updated with selected digital offers on a transactional basis rather than as a batch transmission. Transactional updates occur at the same rate as the selected digital offer is received, hence real-time. Conversely, a batch transmission occurs when selected digital offers are stored in a queue and transmitted at a specified time or after a specified period of time. Real-time POS integration may allow for a user 24 in, for example, a retail store to download an offer to a user account or mobile device for immediate redemption.

As previously disclosed, the POS system 22 may include or be associated with a loyalty system 76. A loyalty system 76 may refer to any retailer membership program that provides benefits (e.g., rewards, discounts, etc.) to consumer members. A consumer member such as the user 24 may provide personal information to the retailer 20 such as name, address, gender, age, shopping preferences, and the like. The user 24 may be assigned a unique identifier such as the consumer identifier that associates the user with the user's personal information. The consumer identifier may be used to uniquely identify the user 24 when transacting with the loyalty system 76. For instance, the consumer identifier may be associated with login credentials used to validate the user's identity when logging in to the retailer's website. Once logged on, the user 24 may have access to a loyalty account through the website, which may include features for the user 24 to select and manage offers. Additionally, the consumer identifier may be stored to a physical loyalty card (not shown) that may be carried by the user 24 when shopping. The user 24 may be identified at a POS location by swiping the user's loyalty card. Other unique identifiers may be entered at the POS location to identify the user 24, such as a telephone number, credit card number, membership identifier, account number, wireless ID tag, or the like.

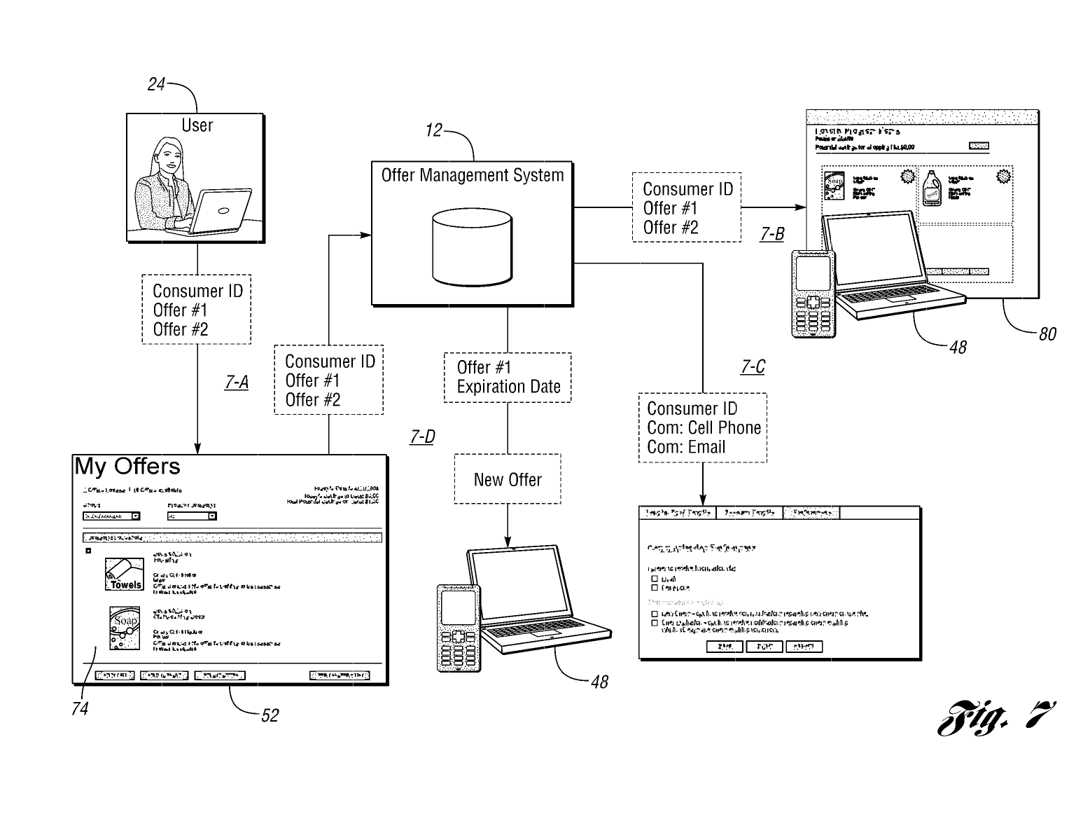

Referring now to FIG. 7, a simplified, exemplary data flow diagram corresponding to both the offer communication preference selection process (referenced at step 330 in FIG. 3) and the user offer management process (referenced at step 370 in FIG. 3) is illustrated in accordance with one or more embodiments of the present application. As seen therein, the offer management system 12 may provide the user 24 the capability to manage selected digital offers 26 and facilitate the communication of offer information 54 corresponding to the digital offers to the user 24. In particular, the user 24 may add offers to, or remove offers from, the user's account via input corresponding to selection features included with the iframe 74 displayed in the single, electronic form 52 (7-A). Moreover, the user 24 may provide input to filter the selected offers in the single, electronic form into, for example, active offers (i.e., offer that are still valid), redeemed offers, or expired offers. Furthermore, the user 24 may request that the offers be sorted according to a number of parameters (e.g., expiration date, value, type of good, CPG, etc).

Additionally, the user 24 may configure several offer communication settings through the user interface provided in the viewing channel owner's website 68. For instance, the user 24 may request that offer information 54 for selected digital offers be printed to a shopping list 80, transmitted to the user via email, SMS/MMS, or downloaded to the user's user device 48 (7-B). Moreover, the user 24 may request whether to receive offer notifications or alerts from the offer management system 12, as well as how the user would like to receive such notifications or alerts (7-C). For instance, the user 24 may request to be notified of an offer's expiration by email or text message. The user 24 may also request that new offers be communicated to the user from the offer management system 12 via email, SMS/MMS, or other distribution channels (7-D). In this regard, the user 24 may then select or ignore the new offer.

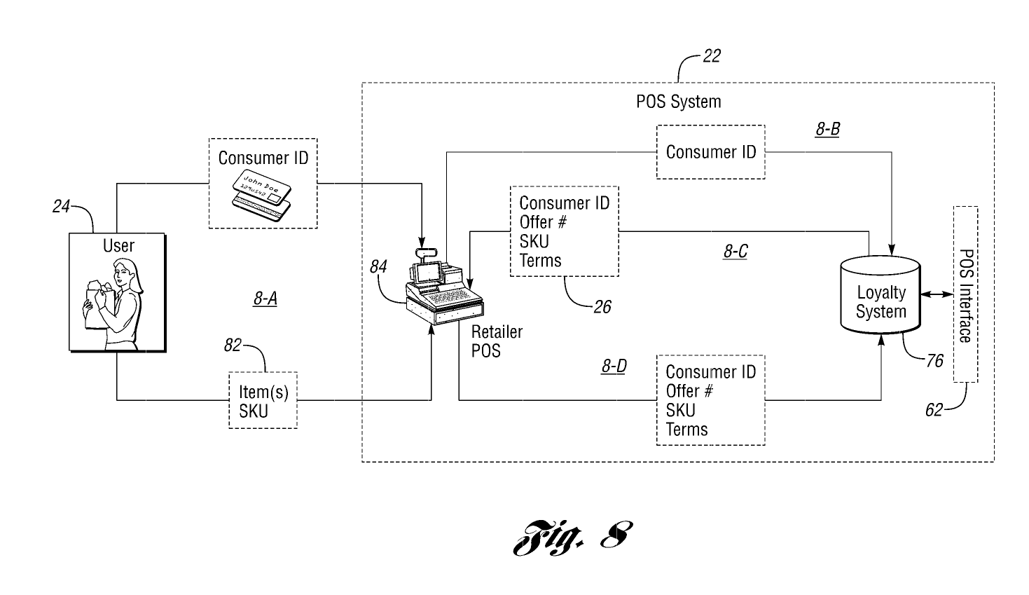

Referring now to FIG. 8, a simplified, exemplary data flow diagram corresponding to the offer redemption process, referenced at step 380 in FIG. 3, is illustrated in accordance with one or more embodiments of the present application. As seen therein, the user 24 may elect to shop in person at a POS location for a retailer 20. The real-time POS integration with the offer management system 12 may allow the user 24 to redeem the digital offer 26 selected online in advance for an in-store purchase at the POS location. To this end, the user 24 may enter the retailer's store and shop for a number of items 82. Once the user 24 has finished shopping, the user may provide the retailer 20 with his or her consumer identifier upon checkout at a POS terminal 84 along with the number of items 82 for purchase (8-A). The POS terminal 84 may be manned by a retail agent (e.g., cashier) or may be a self-checkout register. Further, the POS terminal 84 may include an input device for receiving the consumer identifier, such as a card reader, wireless signal receiver, scanner or keypad. Accordingly, the user 24 may be identified at checkout by input corresponding to the consumer identifier at the POS terminal 84 (e.g., a loyalty card swipe). In turn, the POS terminal 84 may transmit the consumer identifier to a retail system (i.e., a loyalty system 76) so that the user's identity may be verified and validated (8-B). Upon verification of the user's identity, the loyalty system 76 may send the digital offer 26 associated with the consumer identifier back to the POS terminal 84 (8-C). The POS terminal 84 may then validate one or more purchased items 82 with the digital offer 26. At the conclusion of the POS transaction, if the user 24 purchased an item associated with the digital offer 26, the POS terminal 84 may apply the digital offer to the purchase, calculate the savings, document the savings on a receipt, and send a record of the redeemed offer transaction to the loyalty system 76 (8-D).

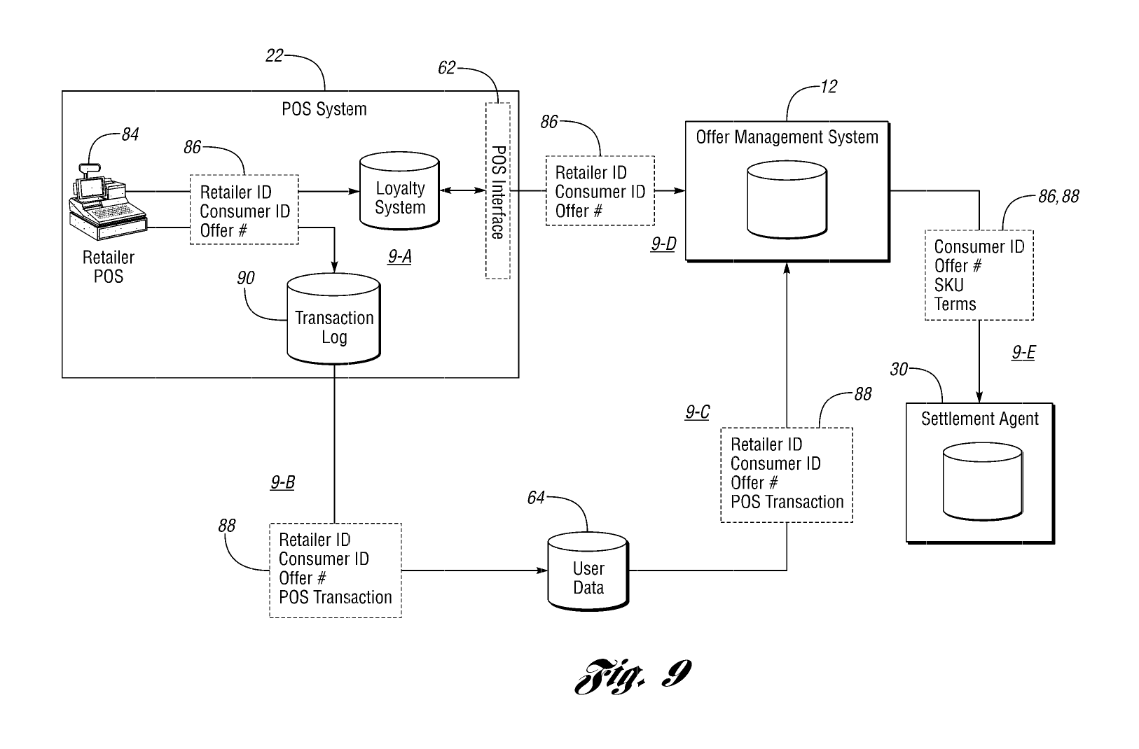

Referring now to FIG. 9, a simplified, exemplary data flow diagram corresponding to the offer settlement process, referenced at step 390 in FIG. 3, in accordance with one or more embodiments of the present application is illustrated. As previously described herein, the system may be updated in real-time to reflect offers redeemed at the POS location. Once the user 24 has redeemed digital offers at the POS location, the offer management system 12 may process, clear or otherwise settle the redeemed offers based on the POS transaction information. The POS system 22 and the offer management system 12 may be updated with redeemed offer information 86 on a transactional basis, rather than by batch updates. Transactional updates occur at the same rate as the purchase transaction, hence real-time. Conversely, a batch update occurs when purchase transactions are stored in a queue and transmitted at a specified time or after a specified period of time in order to update the system. As shown in FIG. 9, in addition to receiving a record of the redeemed offer into the loyalty system 76, the POS system 22 may also capture the complete POS transaction details 88 into a transaction log 90 (9-A). The transaction log 90 may record additional details about redeemed offer that can facilitate the clearing process, such as the true value of the offer, actual savings, date of purchase, purchase price, store ID. Additionally, the transaction log 90 may capture transaction details corresponding to each of the number of items 82 purchased at the POS location. In this regard, the transaction log 90 may actually provide an electronic record of the purchase receipt. The POS transaction details 88 may be stored in the user database 64 as purchase history data for future targeting purposes (9-B). Moreover, the POS transaction details 88 may be received by the offer management system 12 to facilitate the clearing and settlement process (9-C).

The offer redemption information 86 corresponding to the redeemed digital offer may be sent from the loyalty system 76 to the offer management system 12 through the POS interface 62 where it can be processed (9-D). Specifically, the offer management system 12 may receive offer information including the offer number, the consumer identifier, and the retailer identifier. The offer redemption information 86 may be processed by the offer management system 12 on a transactional so that the redeemed offer may be withdrawn from the user's loyalty account, thereby preventing the same user from redeeming the same offer more than once. Moreover, the offer management system 12 may send a record of the offer redemption information 86 and the POS transaction details 88 to the settlement agent 30 so the redeemed offers may be cleared and the accounts settled between the entities involved in the offer transaction (9-E).

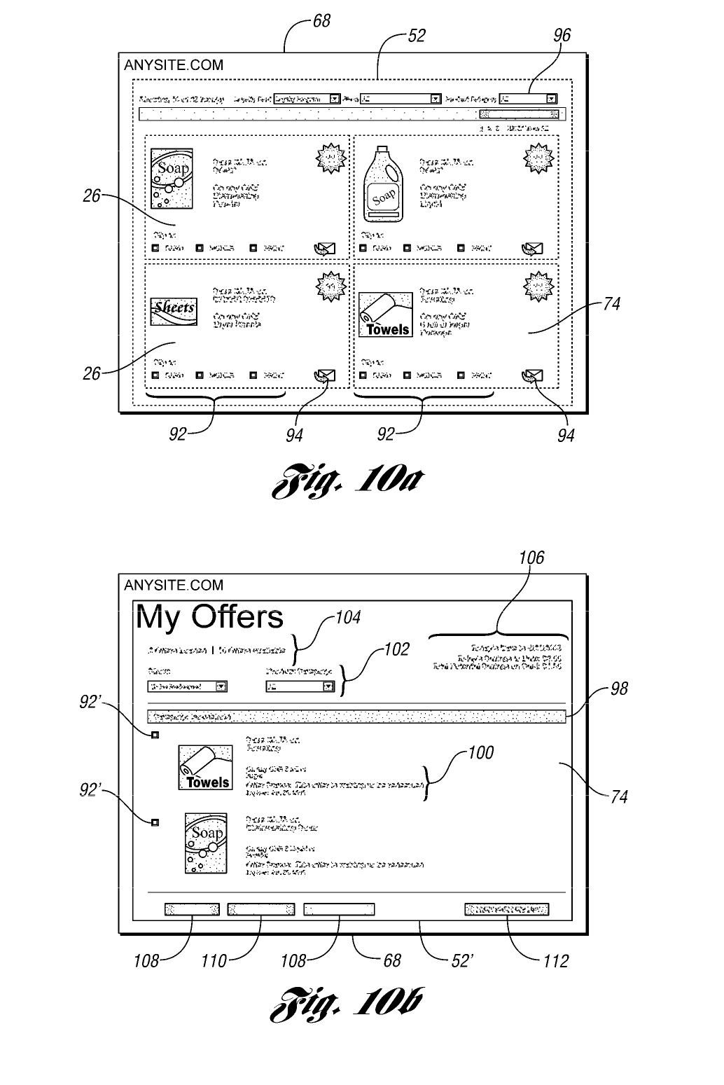

Referring now to FIG. 10a, a simplified, exemplary diagram of the single, electronic form 52 according to one or more embodiments of the present application is shown in greater detail. The electronic form 52 may be displayed on a webpage of a viewing channel owner's website 68 and may include multiple pages. The electronic form 52 may include a number of offers 26 aggregated by the offer management system 12 including offers arbitrated, filtered and targeted to a user 24. Accordingly, the electronic form 52 displaying targeted offers may not be displayed until the user logs on to the viewing channel owner's website 68. To this end, the offer management system 12 may provide a consumer interface that blends into the viewing channel owner's website 68. The user interface can allow users to interact with the offer management system 12 seamlessly without appearing to leave the viewing channel owner's website 68. The user interface may provide a look and feel consistent with the viewing channel owner's website 68 and may maintain consistent menus and site navigation. In this regard, users may be unaware that they are actually interacting with another website in addition to the viewing channel owner's website 68. The user interface or portal for accessing aggregated, targeted offers may be branded and hosted on the viewing channel owner's website. The user interface can provide single sign-on so that users may access downloadable offers aggregated by the offer management system 12 just as easily as they engage with other content on the viewing channel owner's website 68.

As previously described, the offer management system 12 may provide an open platform capable of aggregating offers from multiple offer providers 18 including retailers, retailer partners, CPG entities, third-party offer providers, advertisers, syndicated sources, media companies, and the like. All offers may be uploaded to the offer management system 12 and presented to users via a single portal so they can easily browse, select and review all available digital offers at one time, in one place. Business rules may guide the presentation order for all offers regardless of source. Upon visiting a viewing channel owner's website 68, the offer management system 12 may interact with the user 24 by displaying references to coupons on the home page or in the navigation bar using iframe technology. As a user 24 navigates the website 68 to view the digital offers 26, the offer management system 12 may display the single, electronic form 52 showing all digital offers, regardless of source, available for redemption. The offer management system 12 may allow the user 24 to browse non-targeted national offers and content without logging into the viewing channel owner's website 68. However, the offer management system 12 may preclude users from accessing or selecting digital offers for printing, downloading to a card, or downloading to a mobile device unless the user 24 logs into the viewing channel owner's website 68. This may ensure that the offer management system 12 can identify the user 24 and prevent duplicate redemption situations (e.g., the user may be unable to both print and download to card the same digital offer).

As previously described, the customer interface may facilitate user interaction with the offer management system 12 as if it is part of the viewing channel owner's website 68. In order to maintain a seamless consumer experience, and avoid multiple log-on pages, a viewing channel owner 50 and the offer management system 12 may share the users' identity. The users 24 may be given access to the digital offers 26 aggregated by the offer management system 12 by simply logging into the viewing channel owner's website 68. The offer management system 12 may provide a single sign-on (SSO) tool that can securely link and exchange the necessary customer identity information between the viewing channel 46 and the offer management system 12. Accordingly, the SSO may mitigate customer frustration and inconvenience caused by being transferred to a separate website requiring an additional or potentially different login credentials. Once logged into the viewing channel owner's website 68, the offer management system 12 may display content similar to that displayed when the user 24 is logged off. However, upon identifying the user 24 through the logon process, the offer management system 12 can display personalized content that may feature any available offers targeted specifically to the user based upon user-specific information 66 about the user 24. Moreover, the offer management system 12 may receive requests from the user 24 to print or download selected offers. To this end, the single, electronic form 52 generated by the offer management system 12 for seamless display by the viewing channel owner's website 68 may be an inline frame (iframe) form.

The electronic form 52 may include one or more digital offers 26 available to the user 24 for redemption at a retailer 20. In addition, the electronic form 52 may include one or more selection features 92 associated with each digital offer 26 displayed. The one or more selection features 92 may capture user input corresponding to a particular offer. For example, the one or more selection features 92 may be checkboxes the user 24 may select. Accordingly, the one or more selection features 92 may include a print checkbox, a card download checkbox, or a mobile download checkbox. The offer management system 12 may download the selected offers to the user's loyalty card or mobile device, or cause the selected offers to be printed based upon which checkbox is selected by the user 24. The electronic form 52 may include additional links associated with each digital offer 26. For instance, each offer may have a corresponding offer details link (not shown), which may take the user to another page or pop-up providing additional offer information and terms. Moreover, each offer 26 may have an email link 94, which may allow the user 24 to share the digital offer 26 with an acquaintance or email the offer details to the customer's email account. The electronic form 52 may also include one or more filters 96 for further refining the digital offers displayed to the user 24. For instance, the user 24 may filter the offers by source, product category, loyalty program, expiration period, etc.

While logged into the viewing channel owner's website 68, the user 24 may also view the offers that have been loaded to the customer's account, regardless of where the offer selection originated. FIG. 10b is simplified, exemplary diagram of a single, electronic form 52′ generated by the offer management system 12 for displaying one or more offers in a user's account in accordance with one or more embodiments of the present application. The selected offers form may be displayed as an iframe 74 in a webpage associated with the user's account where the user 24 may manage them. As seen therein, the electronic form 52′ may include at least one category banner 98 for organizing selected offers by product category. The electronic form 52′ may also include an offer status indicator 100 for each selected offer that indicates whether the offer is available, has been redeemed, or has expired. The electronic form 52′ may also include a sort field 102. Correspondingly, the selected offers may be sorted by any number of criteria based upon a selection by the user 24. For instance, the selected offers may be sorted by offer status, product category, expiration date, etc. The electronic form 52′ may also include an offer meter 104. As shown, the offer meter 104 may indicate the total number of offers loaded to the user's account, as well as the total number of offers available at the present time. Additionally, the electronic form 52′ may include a savings status indicator 106, which can provide a running total of how much the user 24 has saved to date or over some other period of time. The savings status indicator 106 may also provide an indication of potential savings available based on the unredeemed offers presently saved to the user's account.

In addition to the foregoing, the electronic form 52′ may also include selection features 92′ that allow the user 24 to amend the offers associated with the user's account. To this end, each offer may have an associated selection box for selecting individual offers to amend. Moreover, the electronic form 52′ may include one or more offer amendment buttons 108. For instance, the electronic form 52′ may include a select all button that may allow all of the offers to be selected at once. The electronic form 52′ may also include a remove button, which, upon clicking, instructs the offer management system 12 to remove selected offers from the user's account so the user 24 may not redeem them. The electronic form 52′ may further include a send button 110. By clicking the send button 110, selected offer may be downloaded to the user's mobile device for use in redeeming the offers, rather than a loyalty card. Finally, the electronic form 52′ may include a print list button 112. The user 24 may request a shopping list via the print list button 112 that includes the selected offers. In this regard, the user 24 may take the list with them when shopping. When the user 24 clicks the print list button 112, a preview of the shopping list may be displayed to the user. The user 24 may then choose to send the list to either a printing device or a mobile device. The shopping list may include additional lines for each product category so that the user 24 may write in other items they wish to purchase at the store in addition to the offer items.

It should be noted that offers redeemable at the retailer 20 may be presented on a number of viewing channel owners' websites 68 (e.g., third-party websites, CPG entity websites, etc.) by the offer management system 12. This may allow for a retailer 20 or offer provider 18 to reach more users 24. If a user 24 elects to download an offer to his or her loyalty card for the retailer when on a non-retailer site, the offer management system 12 may prompt the user 24 to use login credentials for the retailer's site in order to download selected offers to the user's loyalty card. By integrating the offer management system 12 in this manner, the downloaded offers may be processed, viewed and supported as if downloaded directly from the retailer's website.

While embodiments and aspects of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Thus, specific details disclosed are merely representative basis for teaching one skilled in the art to practice the present invention.

What is claimed is:

1. A method for managing, selecting and distributing offers with a computer system including a computer and a database, wherein the computer and database are in electrical communication with each other, the method comprising:
receiving by the computer a number of offers from a first source and a number of offers from a second source, wherein the first source is different than the second source;
aggregating by the computer the number of offers from the first source and the number of offers from the second source to obtain an aggregation of offers;
for each offer from the aggregation of offers, determining whether one or more designated retailers provide at least one item associated with the offer;
storing by the computer the aggregation of offers on the database;
receiving by the computer user-specific information for one or more users;
selecting one or more offers from the aggregation of offers for the one or more users based on the user-specific information to obtain one or more selected aggregated offers; and
transmitting the one or more selected aggregated offers so that the one or more selected aggregated offers are distributed to the one or more users.

2. The method of claim 1, wherein the user-specific information includes media behavior data relating to the one or more users.

3. The method of claim 1, wherein the user-specific information includes purchasing behavior data relating to the one or more users.

4. The method of claim 1, further comprising receiving selection information from an offer provider relating to the first source or the second source.

5. The method of claim 4, wherein the selecting step includes selecting one or more offers from the aggregation of offers for the one or more users based on the user-specific information and the selection information to obtain the one or more selected aggregated offers.

6. The method of claim 1, further comprising receiving selection information from at least one of the designated retailers.

7. The method of claim 6, wherein the selecting step includes selecting one or more offers from the aggregation of offers for the one or more users based on the user-specific information and the selection information to obtain the one or more selected aggregated offers.

8. The method of claim 1, wherein the user-specific information includes demographic data relating to the one or more users.

9. The method of claim 8, wherein the demographic data includes geographic data relating to the one or more users.

10. The method of claim 9, wherein the selecting step includes selecting one or more offers from the aggregation of offers for the one or more users based on the user-specific information, including the geographic data, to obtain one or more selected aggregated offers.

11. The method of claim 9, wherein the selecting step includes restricting the selection of one or more offers from the aggregation of offers for the one or more users based on the user-specific information, including the geographic data, to obtain one or more selected aggregated offers.

12. The method of claim 9, wherein the geographic data includes national, regional and localized geographic data, and the aggregation of offers includes a number of national offers, a number of regional offers, and a number of local offers.

13. The method of claim 12, wherein the selecting step includes selecting one or more national offers from the number of national offers for the one or more users based on the user-specific information, including the national geographic data, to obtain one or more selected national aggregated offers.

14. The method of claim 12, wherein the selecting step includes selecting one or more regional offers from the number of regional offers for the one or more users based on the user-specific information, including the regional geographic data, to obtain one or more selected regional aggregated offers.

15. The method of claim 12, wherein the selecting step includes selecting one or more localized offers from the number of localized offers for the one or more users based on the user-specific information, including the localized geographic data, to obtain one or more selected localized aggregated offers.

16. The method of claim 1, wherein the user-specific information includes user shopping preference data.

17. The method of claim 16, wherein the shopping preference data includes category, product and/or brand data.

18. The method of claim 1, further comprising displaying the one or more selected aggregated offers to the one or more users.

19. A computer system for managing, selecting and distributing offers including a computer and a database that are in electronic communication with each other, the computer having a central processing unit (CPU) for executing machine instructions and a memory for storing machine instructions that are to be executed by the CPU, the machine instructions when executed by the CPU implement the following functions:
receiving a number of offers from a first source and a number of offers from a second source, wherein the first source is different than the second source;
aggregating the number of offers from the first source and the number of offers from the second source to obtain an aggregation of offers;
for each offer from the aggregation of offers, determining whether one or more designated retailers provide at least one item associated with the offer;
storing the aggregation of offers on the database;
receiving user-specific information for one or more users;
selecting one or more offers from the aggregation of offers for the one or more users based on the user-specific information to obtain one or more selected aggregated offers; and
transmitting the one or more selected aggregated offers so that the one or more selected aggregated offers are distributed to the one or more users.

20. A method for managing, selecting and distributing offers with a computer system including a computer and a database, wherein the computer and database are in electrical communication with each other, the method comprising:
receiving by the computer a number of offers from a first source and a number of offers from a second source, wherein the first source is different than the second source;
aggregating by the computer the number of offers from the first source and the number of offers from the second source to obtain an aggregation of offers;
storing by the computer the aggregation of offers on the database;
identifying a competing offer scenario between at least two offers in the aggregation of offers;
arbitrating the competing offer scenario based on a number of offer groupings, an offer hierarchy for the number of offer groupings, and the at least two offers included in the competing offer scenario to obtain at least one arbitrated offer based on the at least two offers included in the competing offer scenario; and
transmitting the at least one arbitrated offer.

21. The method of claim 20, wherein the number of offer groupings includes at least two offer groupings.

22. The method of claim 20, further comprising receiving the number of offer groupings from the first source or the second source.

23. The method of claim 20, further comprising receiving the offer hierarchy for the number of offer groupings from the first source or the second source.

24. The method of claim 21, wherein the at least two offer groupings are selected from the group consisting of: a targeted offer group, a non-targeted offer group, an exclusive offer group, a syndicated content offer group, and a non-enumerated offer group.

25. The method of claim 21, wherein the arbitrating step includes identifying the offer group for each of the at least two offers in the competing offer scenario and selecting the at least one arbitrated offer based on the offer hierarchy and the offer group for each of the at least two offers.
